(19) United States
(12) Patent Application Publication
(10) Pub. No.: US 2015/0186890 A1
(43) Pub. Date: Jul. 2, 2015

(54) Method, Device And System For Data Processing

(71) Applicant: Tencent Technology (Shenzhen) Company Limited, Shenzhen (CN)

(72) Inventors: Shanlin LI, Shenzhen (CN); Wenxing WANG, Shenzhen (CN); Kan ZHANG, Shenzhen (CN); Jing GAO, Shenzhen (CN)

(21) Appl. No.: 14/567,958

(22) Filed: Dec. 11, 2014

Related U.S. Application Data
(63) Continuation of application No. PCT/CN2014/082311, filed on Jul. 16, 2014.

(30) Foreign Application Priority Data
Dec. 31, 2013 (CN) 201310753047.0

(51) Int. Cl. G06Q 20/40; G06Q 20/32; G06Q 50/00

(52) U.S. Cl. CPC G06Q 20/4014; G06Q 50/01; G06Q 20/3226

(57) ABSTRACT

Method and device of processing a security transaction are disclosed. The method includes: receiving a transaction request from the mobile device, wherein the transaction request specifies a purchase transaction for a financial product; in accordance with a determination that the user does not have any existing account with the broker of the financial product, identifying a payment account of the user that has been bound with the user's account of the social networking platform; and based on user identity information and bank account information associated with the payment account, establishing a new account with the broker of the financial product on behalf of the user; and requesting the broker to execute the purchase transaction using the new account established by the server on behalf of the user.

### RELATED APPLICATIONS

This application is a continuation application of PCT Patent Application No. PCT/CN2014/082311, entitled “METHOD, DEVICE AND SYSTEM FOR DATA PROCESSING” filed on Jul. 16, 2014, which claims priority to Chinese Patent Application No. 201310753047.0, entitled “Method, Device and system for data processing,” filed on Dec. 31, 2013, both of which are incorporated by reference in their entirety.

### FIELD OF THE TECHNOLOGY

The present disclosure relates to computer data processing technology, and especially to a data processing method, device and system.

### BACKGROUND OF THE TECHNOLOGY

With the development of the society and the improvement of the standard of living, more and more people will choose to process various services with intelligent terminal devices such as a mobile phone, a tablet PC and a personal computer. For example, people can obtain services from funds, stocks and banks, via an electronic device and a network at home.

The existing service processing under regulation requires real name authentication of a user, which would generally bring a large amount of data entry work for registration and the real name authentication, etc. to the user, and the data entry work is long and tedious.

Therefore, it is desirable to have a quick and flexible way for a user to obtain a service that needs identity authentication.

### SUMMARY

In some embodiments, a method of processing a financial product transaction is performed at a server of a social network platform having one or more processors and memory storing instructions for execution by the one or more processors. The method includes: receiving a transaction request from the mobile device, wherein the transaction request specifies a purchase transaction for a financial product; in response to the transaction request, determining whether the user has an existing account with a broker of the financial product; in accordance with a determination that the user does not have any existing account with the broker of the financial product, identifying a payment account of the user that has been bound with the user's account of the social networking platform; and based on user identity information and bank account information associated with the payment account, establishing a new account with the broker of the financial product on behalf of the user; and requesting the broker to execute the purchase transaction using the new account established by the server on behalf of the user.

In another aspect, a device comprises one or more processors, memory, and one or more program modules stored in the memory and configured for execution by the one or more processors. The one or more program modules include instructions for performing the method described above. In yet another aspect, a non-transitory computer readable storage medium having stored thereon instructions, which, when executed by a device, cause the device to perform the method described herein.

### BRIEF DESCRIPTION OF THE DRAWINGS

The aforementioned features and advantages of the technology as well as additional features and advantages thereof will be more clearly understood hereinafter as a result of a detailed description of preferred embodiments when taken in conjunction with the drawings.

FIG. 1 is a schematic flowchart of a data processing method in accordance with some embodiments;

FIG. 2 is a schematic flowchart of a data processing method in accordance with some embodiments;

FIG. 3 is a schematic flowchart of a data processing method in accordance with some embodiments;

FIG. 4 is a schematic diagram of communication interaction among various servers in the data processing method in accordance with some embodiments;

FIG. 5 is a schematic flowchart of a data processing method in accordance with some embodiments;

FIG. 6 is a schematic flowchart of a data processing method in accordance with some embodiments;

FIG. 7 is a schematic flowchart of a data processing method in accordance with some embodiments;

FIG. 8 is a schematic structural diagram of a data processing system in accordance with some embodiments;

FIG. 9 is a flowchart of a method of processing a financial product transaction in accordance with some embodiments;

FIG. 10 is a schematic structural diagram of a data processing device in accordance with some embodiments;

FIG. 11 is a schematic structural diagram of a data processing device in accordance with some embodiments;

FIG. 12 is a schematic structural diagram of a first processing module in FIG. 10;

FIG. 13 is a schematic structural diagrams of a receiving module in FIG. 10;

FIG. 14 is a schematic structural diagram of a server in accordance with some embodiments;

FIG. 15 is a schematic structural diagram of a data processing device in accordance with some embodiments;

FIG. 16 is a schematic structural diagram of a user terminal in accordance with some embodiments;

FIG. 17 is a schematic structural diagram of a data processing device in accordance with some embodiments;

FIG. 18 is a schematic structural diagram of a server in accordance with some embodiments;

FIG. 19 is a schematic structural diagram of a data processing device in accordance with some embodiments;

FIG. 20 is a schematic structural diagram of a server in accordance with some embodiments; and

FIG. 21 is a schematic structural diagram of a server of processing a transaction in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The technical solutions in embodiments of the present disclosure are hereinafter described clearly and completely with reference to the accompanying drawings in accordance with some embodiments. Evidently, the described embodiments are only some embodiments of the present technology, rather than all embodiments of the present technology. All other embodiments obtained by a person skilled in the art based on the embodiments of the present disclosure without creative efforts shall fall within the scope of protection of the present disclosure.

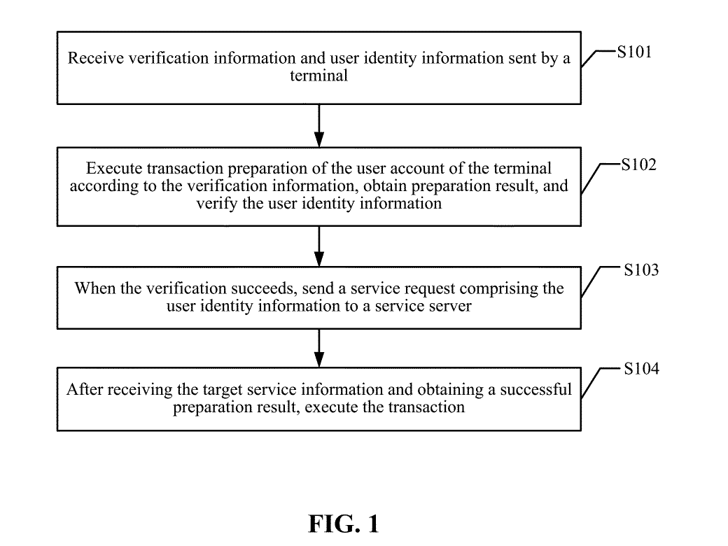

FIG. 1 a schematic flowchart of a data processing method in accordance with some embodiments. The method is applied to social network applications, such as an instant communication application and a social communication application, comprising various servers for communication and data processing. The method comprises the following steps.

In accordance with some embodiments, in step S101, a data server receives verification information and user identity information sent by a terminal.

The terminal is a user terminal of the user side with a networking function, such as a smart phone, a tablet PC and an intelligent wearable device, which can execute applications such as an instant communication application and a social communication application. The user can perform information interaction with applications, such as an instant communication application and a social communication application, comprising a variety of the data processing servers for communication and data processing, via a corresponding user account number.

In accordance with some embodiments, a corresponding function trigger button is particularly added to applications such as an instant communication application and a social communication application installed on a terminal. When a user clicks the function trigger button, a data processing event is generated, and the terminal detects the event and acquires data confirmation information and user identity information.

In accordance with some embodiments, the verification information is used to trigger the data server to perform transaction preparation, and the verification information provides information such as an account and a password for authorizing a transaction operation. The verification information may also comprise particular item information, such as fund and stock information, the user identity information, and the ID card number, the real name of the user, etc. When verifying the real identity of the user via a user identity verification service provided by a bank, the user identity information may also particularly comprise a bank card number.

The verification information and user identity information can both be filled by providing a man-machine interface to receive inputs from the user. Of course, the user identity information and the corresponding verification information can also be acquired from user profile in the terminal.

In accordance with some embodiments, in step S102, the data server executes transaction preparation, obtains preparation result, and verifies the user identity information.

The data server first verifies the corresponding account and password in the verification information according to the verification information, and accomplishes the transaction preparation for the account in the verification information when the verification succeeds.

The data server is also used for verifying the user identity information. A particular verification method is communicating with a corresponding server in a household-registration service. And the corresponding server verifies the ID card number and the real name comprised in the user identity information notifies the data server when the verification succeeds. The data server can also go to a bank server of a corresponding bank to verify whether the ID card number and the real name are true according to the ID card number, the real name and the bank card number in the user identity information. If they are true, then the verification succeeds, and the bank server notifies the data server that the verification succeeds.

In accordance with some embodiments, in step S103, when the verification succeeds, a service request comprising the user identity information is sent to a service server.

In some embodiments, a service server processes a relevant service provided by a third party. For example, a server provides fund account opening. The service server can particularly be a system composed of a server group.

The data server initiates a service request to the service server and carries user identity information such as the ID card number and the real name of the user in the service request, and the service request is particularly used for requesting a service server of the third party to execute a corresponding service. After receiving the service request of the data server, the service server extracts the user identity information from the service request and verifies information such as the ID card number and the real name therein. When the verification succeeds, the service server will generate corresponding service information. Particularly, a user name of a social network application is taken as the user name of the opened account. Target service information, such as a subscription order, is generated and sent to the data server. In some embodiments, the target service information is order information about the agreed content, so as to accomplish the processing of the corresponding service for the user directly.

In accordance with some embodiments, in step S104, after receiving the target service information and obtaining a successful preparation result, the data server executes the transaction.

In some embodiments, after receiving the target service information, the data server can detect whether the preparation result is a success notification. If it is a success notification, then the data server executes the transaction, and money is transferred to the user account corresponding to the service server from the user account corresponding to the terminal. If success notification is not obtained or it is information about processing failure, a processing failure notification is sent out to end the current data processing.

In some embodiments, the transaction uses an account or a bank card to complete the transfer of an amount value from the user account corresponding to the terminal to the user account corresponding to the service server, such as an account of a fund company, finally realizing user data processing. After the data processing is completed, the data server can also send a notification message to the terminal to notify the corresponding user of data processing success.

It needs to be noted that the data server is a server configured with a corresponding processing logic, and can also be two servers configured with different processing logics, with the two servers accomplishing the above-mentioned data processing method via information interaction.

The data processing method provided in accordance with some embodiments can perform real name authentication and a corresponding service processing for a user, after the user has triggered corresponding data processing via a terminal, i.e. the whole data processing is accomplished automatically at the backend.

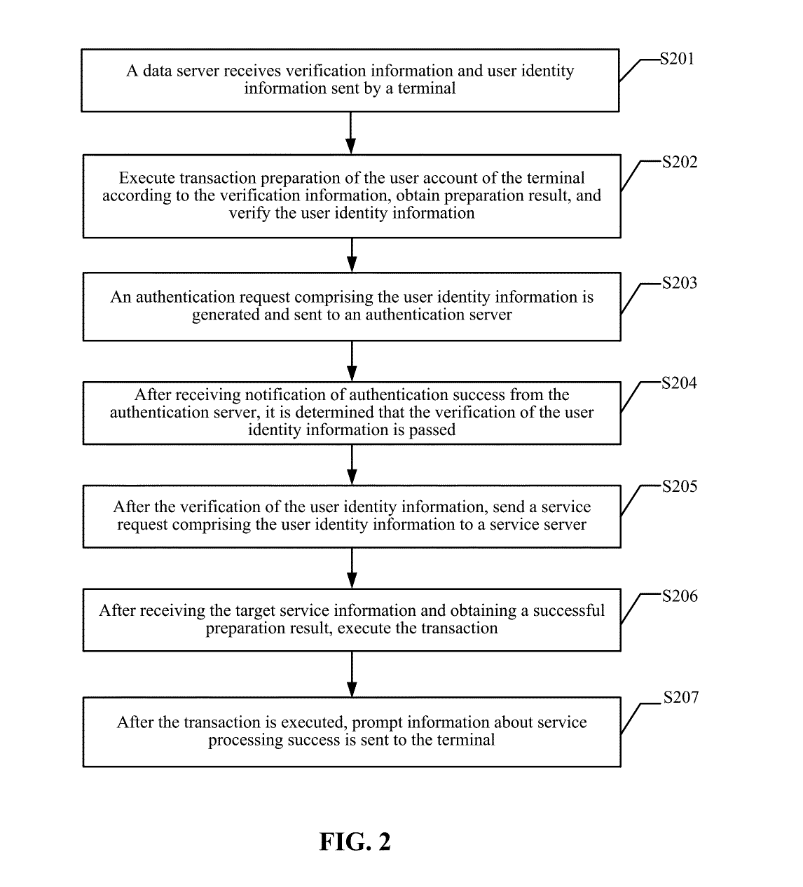

FIG. 2 is a schematic flowchart of a data processing method in accordance with some embodiments. The method comprises the following steps.

In accordance with some embodiments, in step S201, a data server receives verification information and user identity information sent by a terminal.

A corresponding function trigger button is particularly added to applications such as an instant communication application and a social communication application installed on the terminal. And when the user clicks the function trigger button, a data processing event is generated, and the terminal detects the event and then acquires the data confirmation information and the user identity information.

In accordance with some embodiments, the step S201 may particularly comprise: receiving a service trigger request generated when the terminal detects a service confirmation event and receiving the user identity information; sending transaction request information to the terminal in response to the service trigger request; and receiving verification information returned by the terminal in response to the transaction request, with the verification information comprising user verification information and amount information. The receiving the user identity information acquired by the terminal comprises: receiving user identity information entered in a user interface displayed when the terminal detects the service confirmation event. And the receiving verification information returned by the terminal in response to the transaction request comprises: receiving verification information entered in a user interface displayed when the terminal receives the transaction request information.

The verification information comprises particular amount information, and user information required for accomplishing transaction, such as an account and a password, and may also comprise particular item information, such as fund and stock information. And the user identity information comprises: information such as an ID card number, a real name and a bank card number.

In accordance with some embodiments, in step S202, the data server executes transaction preparation and obtains preparation result.

The data server first verifies the corresponding account and password in the verification information, and then accomplishes the transaction preparation for the account in the verification information according to particular amount information therein when the verification succeeds.

In accordance with some embodiments, in step S203, the data server generates an authentication request comprising the user identity information and sends it to an authentication server.

The authentication server is a relevant bank server and the like which can provide user information authenticity verification. Such bank servers verify the user identity information and notify the first server when the verification succeeds.

In accordance with some embodiments, in step S204, after receiving notification of authentication success from the authentication server, the data server determines that the verification succeeds.

In accordance with some embodiments, in step S205, when the verification succeeds, the data server sends a service request comprising the user identity information to a service server.

The data server initiates a service request to the service server and carries user identity information such as the ID card number and the real name of the user in the service request, and the service request is particularly used for requesting a service server of the third party to execute a corresponding service. After receiving the service request of the data server, the service server extracts the user identity information from the service request and verifies information such as the ID card number and the real name therein. When the verification succeeds, the service server will generate corresponding service information so as to accomplish the current service processing.

In accordance with some embodiments, in step S206, after receiving the target service information and obtaining a successful preparation result, the data server executes the transaction.

In accordance with some embodiments, in step S207, after executing the transaction, the data server sends prompt information about service processing success to the terminal.

After the data processing is completed, the data server can also send a notification message to the terminal to notify the corresponding user of data processing success.

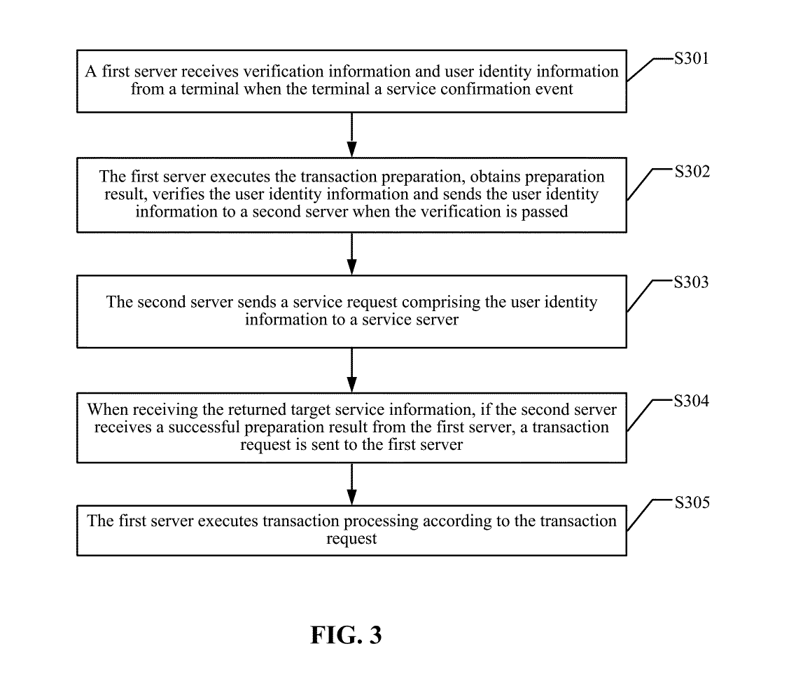

FIG. 3 is a schematic flowchart of a data processing method in accordance with some embodiments.

In accordance with some embodiments, in step S301, a first server receives verification information and user identity information from a terminal when the terminal a service confirmation event;

In accordance with some embodiments, in step S302, the first server executes transaction preparation of a user account corresponding to the terminal according to the verification information to obtain preparation result, and verifies the user identity information and sends the user identity information to a second server when the verification succeeds;

In accordance with some embodiments, in step S303, the second server sends a service request comprising the user identity information to a service server;

In accordance with some embodiments, in step S304, when receiving the target service information returned by the service server, if the second server receives a successful preparation result, a transaction request is sent to the first server; and

In accordance with some embodiments, in step S305, the first server executes transaction processing according to the transaction request.

The S305 may particularly comprise: the first server executes transaction processing according to the transaction request, comprising: the first server acquires the account of the user corresponding to the service server, and the first server transfers the amount to the user account corresponding to the service server from the user account corresponding to the terminal.

It needs to be noted that the particular implementations of the above-mentioned terminal, first server and second server can refer to the explanation about corresponding functions in the embodiments corresponding to the above-mentioned FIG. 1 and FIG. 2

The data processing method provided in accordance with some embodiments can perform real name authentication and a corresponding service processing for a user, after the user has triggered corresponding data processing via a terminal, i.e. the whole data processing is accomplished automatically at the background; the user's operation is simplified, the user's time is saved, and the automation and intellectualization requirements of service processing by the user are satisfied.

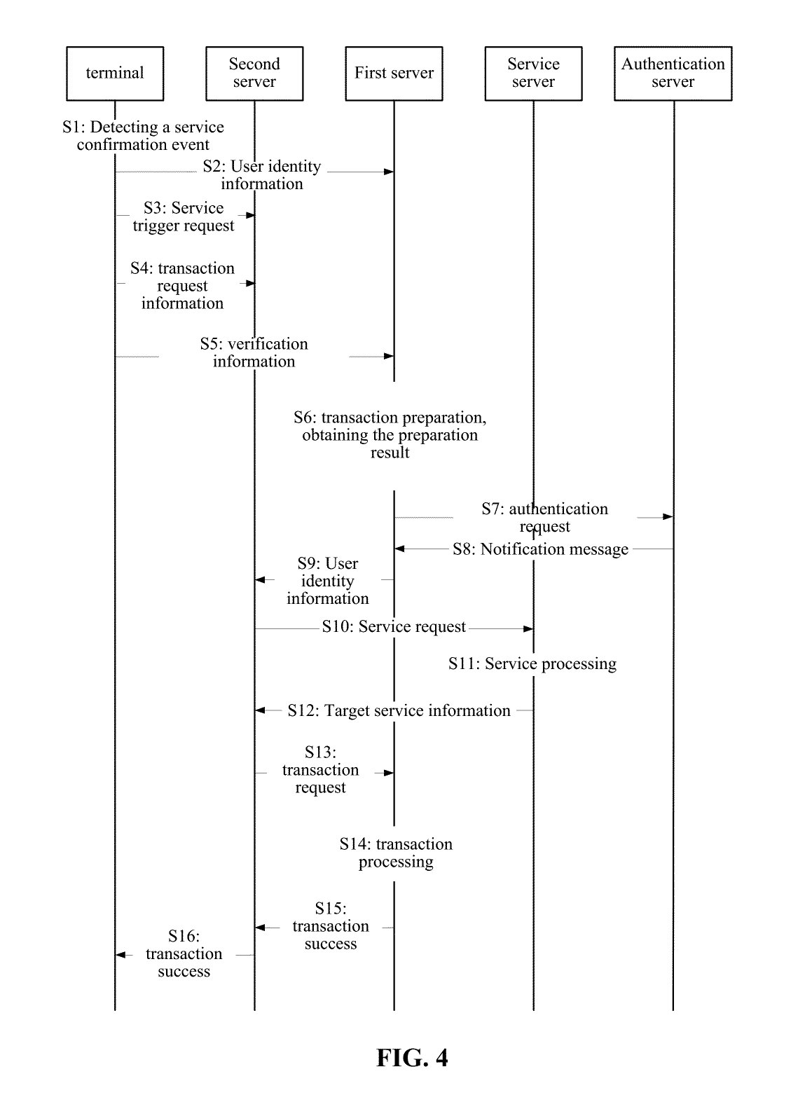

FIG. 4 is a schematic diagram of communication interaction among various servers in the data processing method in accordance with some embodiments, the method in accordance with some embodiments comprises:

In accordance with some embodiments, in step S1, a terminal detects a service confirmation event, and if a service confirmation event is detected, steps S2 and S3 below will be executed. In some embodiments, the steps S2 and S7 to S12 and the steps from S3 to S6 are executed simultaneously.

In accordance with some embodiments, in step S2, the terminal sends user identity information to a first server. A user interface is provided to request the user to enter the user identity information, and the user identity information may particularly comprise information such as the ID card number and the real name of the user.

In accordance with some embodiments, in step S3, the terminal sends a service trigger request to a second server.

In accordance with some embodiments, in step S4, the second server returns transaction request information in response to the service trigger request.

In accordance with some embodiments, in step S5, the terminal sends verification information to the first server. Transaction verification information such as the user account and the password and the particular amount are sent to the first server, and the first server is authorized to execute transaction preparation. The terminal can request the user to enter corresponding transaction verification information and particular amount information by displaying a user interface.

In accordance with some embodiments, in step S6, the first server executes transaction preparation of the user account corresponding to the terminal according to the verification information to obtain preparation result.

Optionally, the first server can return the processing result of the transaction preparation to the terminal to notify whether the terminal user can accomplish preparation for transaction.

In accordance with some embodiments, in step S7, the first server sends an authentication request to an authentication server, with the authentication request comprising the user identity information submitted in the step S2.

In accordance with some embodiments, in step S8, when the verification succeeds, the authentication server sends a notification message to the first server to notify the first server that the verification succeeds.

In accordance with some embodiments, in step S9, the first server sends the user identity information to the second server.

In accordance with some embodiments, in step S10, the second server sends a service request to a service server. The service request comprises the user identity information.

In accordance with some embodiments, in step S11, the service server executes service processing to obtain target service information.

In accordance with some embodiments, in step S12, the service server sends target service information to the second server.

In accordance with some embodiments, in step S13, the second server receives the target service information and a successful preparation result, and sends a transaction request to the first server.

In accordance with some embodiments, in step S14, the first server accomplishes transaction processing. Comprised are acquiring the account of the user corresponding to the service server. And transferring the amount to the user account corresponding to the service server from the user account corresponding to the terminal

In accordance with some embodiments, in step S15, the first server notifies the second server of transaction success.

In accordance with some embodiments, in step S16, the second server notifies the terminal of transaction success.

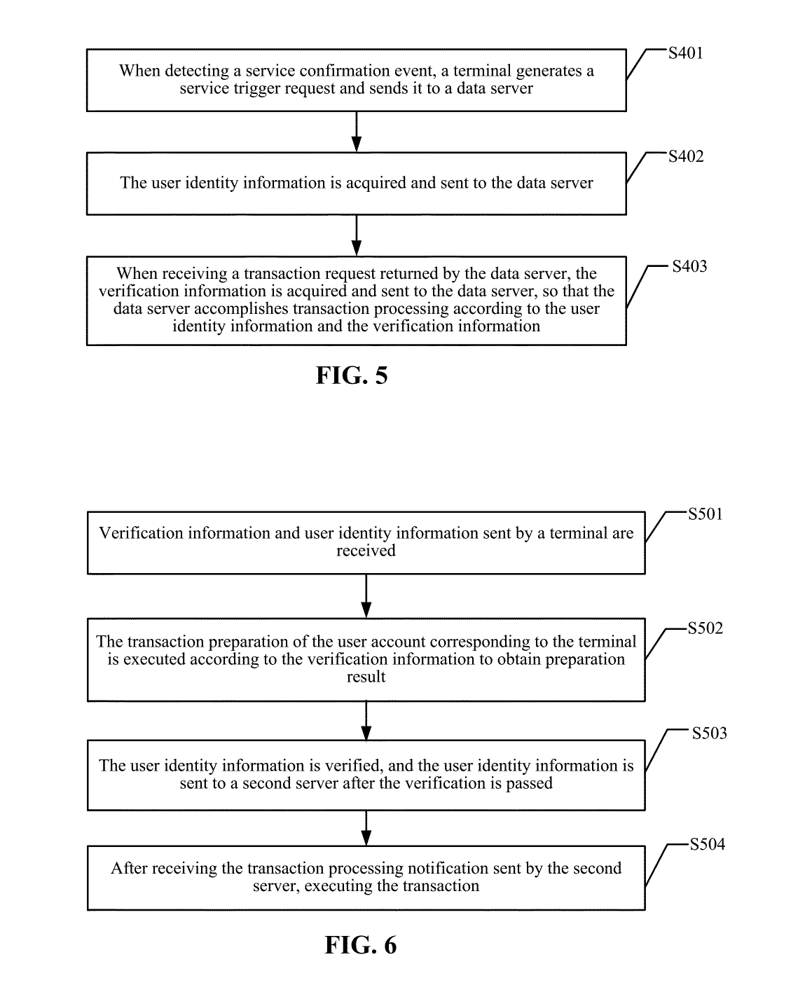

FIG. 5 is a schematic flowchart of a data processing method in accordance with some embodiments. The method is applied to user terminals with a networking function, such as a smart phone, a tablet PC and an intelligent wearable device. The method comprises the following steps.

In accordance with some embodiments, in step S401, when detecting a service confirmation event, a terminal generates a service trigger request and sends it to a data server.

The user can perform information interaction with applications, such as an instant communication application and a social communication application, comprising a variety of the data processing servers for communication and data processing, via a corresponding user account number.

A corresponding function trigger button is particularly added to applications such as an instant communication application and a social communication application installed on the terminal. And when the user clicks the function trigger button, a data processing event is generated, and the terminal detects the event and then acquires the data confirmation information and the user identity information.

In accordance with some embodiments, in step S402, the terminal acquires the user identity information and sends it to the data server.

In accordance with some embodiments, in step S403, when receiving a transaction request, the terminal acquires the verification information and sends it to the data server, so that the data server accomplishes transaction processing according to the user identity information and the verification information.

Particularly, the terminal accomplishing the data processing method in accordance with some embodiments can also refer to the description of the embodiments corresponding to the above-mentioned FIGS. 1-3.

FIG. 6 is a schematic flowchart of a payment processing method in accordance with some embodiments, the method in accordance with some embodiments is applied to the above-mentioned first server, and particularly, the method comprises the following steps.

In accordance with some embodiments, in step S501, the first server receives verification information and user identity information sent by a terminal.

The particular implementation of the terminal obtaining the verification information and user identity information can refer to the description of the embodiments corresponding to the above-mentioned FIG. 1 to FIG. 5.

In accordance with some embodiments, in step S502, the first server executes transaction preparation and obtains preparation result.

In accordance with some embodiments, in step S503, the first server verifies the user identity information and sends the user identity information to a second server when the verification succeeds.

In accordance with some embodiments, in step S504, after receiving a transaction processing notification sent by the second server, the first server executes the transaction.

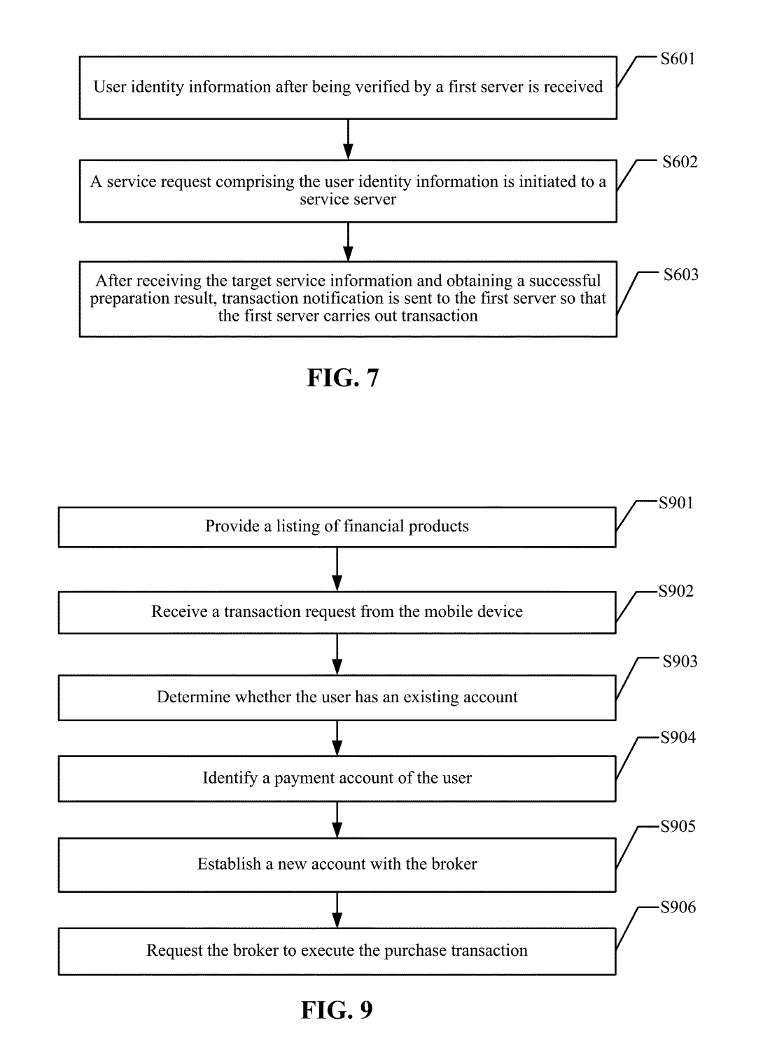

FIG. 7 is a schematic flowchart of a payment processing method in accordance with some embodiments. The method in accordance with some embodiments is applied to various financial value-added servers, i.e. the above-mentioned second server. The method comprises the following steps.

In accordance with some embodiments, in step S601, a second server receives user identity information after being verified by a first server;

The methods of the first server acquiring and verifying user identity information can refer to the description of the embodiments corresponding to the above-mentioned FIG. 1 to FIG. 6.

In accordance with some embodiments, in step S602, the second server initiates a service request comprising the user identity information to a service server.

The service server can particularly be a relevant server provided by a third-party fund company, etc., and can particularly be a system composed of a server group. After receiving a service request from the second server, the service server extracts the user identity information from the service request with an agreed method, and verifies information such an the ID card number and the real name therein; when the verification succeeds, the service server will return target service information to the second server, such as order information.

In accordance with some embodiments, in step S603, the second server sends a transaction notification to the first server.

The transaction processing executed by the first server comprises: the first server acquires the account of the user corresponding to the service server, and transfers the amount to the user account corresponding to the service server from the user account corresponding to the terminal.

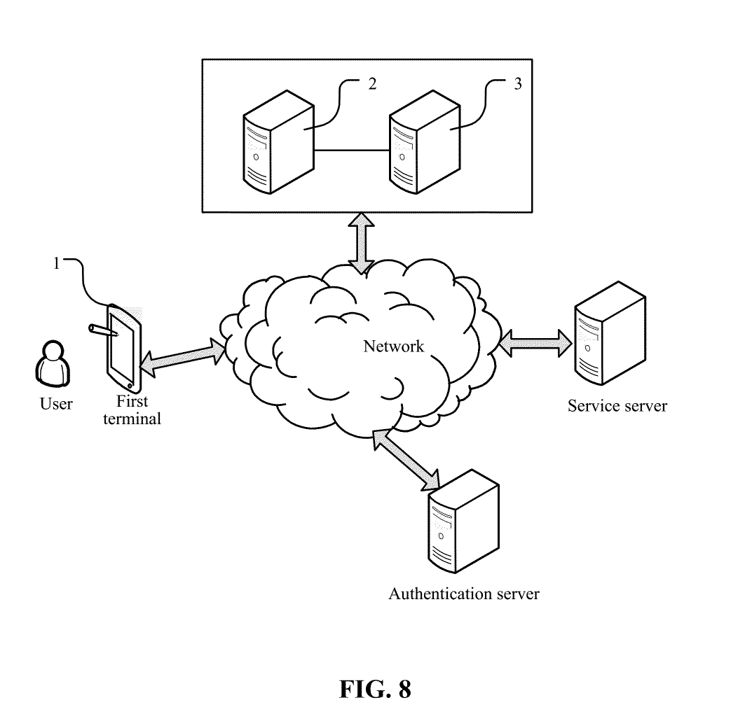

FIG. 8 is a schematic structural diagram of a data processing system in accordance with some embodiments, the system in accordance with some embodiments comprises: a terminal 1, a first server 2 and a second server 3.

In accordance with some embodiments, the terminal 1 is used for sending verification information and user identity information to the first server 2.

In accordance with some embodiments, the first server 2 is used for executing transaction preparation, verifying the user identity information and sending the user identity information to the second server 3 when the verification succeeds.

In accordance with some embodiments, the second server 3 is used for sending a service request comprising the user identity information to the server.

In accordance with some embodiments, the first server 2 is also used for executing transaction processing according to the transaction request.

When being used for executing transaction according to the transaction request, the first server 3 is particularly used for: acquiring the account of the user corresponding to the service server, and transferring the amount to the user account corresponding to the service server from the user account corresponding to the terminal.

In accordance with some embodiments, a corresponding function trigger button is particularly added to applications such as an instant communication application and a social communication application installed on a terminal 1. And when a user clicks the function trigger button, a data processing event is generated. The terminal 1 detects the event and then acquires the data confirmation information and the user identity information.

Particularly, the particular implementations of the above-mentioned terminal 1, first server 2 and second server 3 can refer to the description of the embodiments corresponding to FIGS. 1-5.

FIG. 9 is a flowchart of a method of processing a financial product transaction in accordance with some embodiments. The method is performed at a server of a social network platform, the server having one or more processors and memory for storing one or more programs to be executed by the one or more processors.

In step S901, in accordance with some embodiments, the server provides a listing of financial products offered by one or more brokers to a user through a mobile device associated with a user account of the social networking platform.

In some embodiments, the step S901 is optional. In some embodiments, the user sees no listing of financial products or brokers but instead enters information identifying a financial product and/or a broker to set up a transaction request.

In some embodiments, financial products include a single security, a basket of securities, bank notes, bonds, derivative contracts, options, indices, insurance policies, commodities, debt issuance, foreign currencies, swaps, etc.

In some embodiments, before providing the listing of financial products to the user, the server receives an initial request from the user, wherein the listing of financial products is provided to the user in response to the initial request. In some embodiments, the initial request includes a mobile device identifier of the mobile device. In some embodiments, the initial request includes an account identifier for the user account of the social network platform.

For example, a user opens a conversation interface on his/her smart phone and sees a recommendation from a friend for a stock. The user selects an icon and opens a transaction interface and the user's mobile phone sends an initial request to the server of the social network platform. After receiving the initial request, the server sends the listing of available financial products to the mobile device. The mobile phone displays the listing so that the user can choose one or more financial products from the listing. In some embodiments, the mobile phone pre-stores the listing of financial products and updates the listing periodically with the server. In some embodiments, the server sends and the mobile phone displays a listing of brokers in addition to the listing of the financial products, for the user to choose from.

In some embodiments, the transaction request is sent after the mobile device receiving predetermined operations on a conversation interface of the mobile device. For example, a user receives a message from a friend through an iPad. The message is a recommendation of a stock from a friend and contains the link. The user selects the link and the iPad displays transaction set-up interface with the recommended stock. After specifying some information of a purchase transaction, such as 1000 shares of the stock, the user confirms his/her intention of the purchase transaction. The iPad then sends a transaction request to the server of the social network platform.

In step S902, in accordance with some embodiments, the server receives a transaction request from the mobile device, wherein the transaction request specifies a purchase transaction for a financial product.

In some embodiments, the purchase transaction is specified with a quantity of a security, an upper limit of the monetary size of the purchase transaction, and/or a selection of the payment account for establishing the new account. For example, a user specifies such information in an interface to fill in details of the purchase transaction. The necessary information for the purchase transaction varies according to the type of the financial product, the intention of the user and prior settings on the mobile device. For example, a user may specify that the desired transaction includes purchasing 1000 IBM stocks, with a dollar amount of no higher than a certain number, and the purchasing fund should be transferred from the user's Morgan Chase account (which is chosen from the three bank accounts that are bound with the user's social network account).

In step S903, in accordance with some embodiments, the server, in response to the transaction request, determines whether the user has an existing account with a broker of the financial product.

In some embodiments, there are multiple brokers that can trade the financial product on behalf of the user. In some embodiments, the server automatically chooses the broker with which the user has already opened an account, if the broker is capable of handling the transaction. In some embodiments, if the user has opened accounts in multiple brokers and has not specified a particular broker in the transaction request, the server returns an inquiry and the mobile device displays an interface asking the user to choose among the multiple brokers.

In some embodiments, a broker of the financial product means a broker that is capable of handling a purchase transaction of the financial product on behalf of the user. In some embodiments, the determining process includes inquiring the broker's capability of handling the purchase transaction of the financial product. In some embodiments, when the user has opened accounts in multiple brokers, each of the brokers is inquired and/or reviewed to determine whether the broker is capable of handling the particular transaction.

In step S904, in accordance with some embodiments, the server, in accordance with a determination that the user does not have any existing account with the broker of the financial product, identifying a payment account of the user that has been bound with the user's account of the social networking platform.

In some embodiments, the payment account is the account the user draws fund from to support the purchase transaction. In some embodiments, the payment account is a saving account, checking account, market account, or any account that may be a source of funding. In some embodiments, identifying the payment account can be based on a user selection in the transaction request, a prior setting of a default payment account by the user, and/or that there is only one account that is bound with the user's account of the social networking platform.

In step S905, in accordance with some embodiments, the server, based on user identity information and bank account information associated with the payment account, establishing a new account with the broker of the financial product on behalf of the user.

In some embodiments, establishing the new account with the broker of the financial product on behalf of the user, further comprises: identifying a bank account and payment authorization information of the user associated with the payment account; sending the payment authorization information to a bank server that manages the bank account to request the user identity information associated with the payment account from the bank server; if the bank authenticates the payment authorization information, receiving the user identity information from the bank server; and establishing the new account with the broker of the financial product for the user using the received user identity information.

In some embodiments, payment authorization information includes an authorization to the bank for transferring certain amount of money to another account, possibly a broker account. The payment authorization information further includes necessary information for the bank to verify the authenticity of the authorization, e.g., the user's payment pin, and username for the payment account. The user identity information includes the information required to open the new account with the broker. Typically, the user identity information includes the user's real name, ID number, date of birth, SSN, home address, home telephone number, etc. In some embodiments, acquiring the user identity information from the bank server needs an agreement from the bank and/or a prior authorization from the user to the bank and the social network platform. The user identity information needed for opening a new account with a broker is usually identical or substantially included in the user identity information that is associated with a bank account. By receiving the user identity information from the bank server, the method saves the user from the tedious process of entering user identity information.

In some embodiments, establishing the new account with the broker of the financial product on behalf of the user, further comprises: obtaining user identity information stored in association with the payment account; and sending the stored user identity information associated with the payment account to a broker server of the broker to establish the new account with the broker of the financial product. For example, the server stores the user identity information locally, and only requests the bank server to transfer the funds to the broker to open the new account. One advantage of saving user identity information locally is that the server of social network needs not to receive such information from the bank server, which simplifies the process and reduces the requirement of cooperation from banks However, it also increases the security concern of storing the user identity information confidentially and safely.

In some embodiments, establishing the new account with the broker of the financial product on behalf of the user, further comprises: identifying a bank account and payment authorization information of the user associated with the payment account; sending the payment authorization information to a bank server that manages the bank account to request that the bank server sends user identity information associated with the payment account to a broker server of the broker; and requesting the broker to establish a new account for the user using the user identity information the broker sever receives from the bank server. For example, the server of social network asks the bank server to send the user identity information to the broker, and let the broker open a new account based on the user identity information received from the bank server. By asking the bank server to directly sending the user identity information to the broker, the server of the social platform does not have to store or forward such information and avoids risk of leaking sensitive information from the server.

In some embodiments, requesting the broker to establish the new account for the user using the user identity information the broker server receives from the bank server further comprises: creating temporary transaction authorization information for the new account; and sending the temporary transaction authorization information in a request to the broker server, wherein the request identifies the bank account of the user. The temporary transaction authorization includes temporary username and password for the new account at the broker.

For example, when the server of social network asks the broker server to open a new account, the server of social network sends the temporary account name and password for the new account, the server of social network also specify the bank account for which the bank server is to provide the user identity information to the broker server. The broker server can use the bank account identifier to correlate the request to open the new account, and the user identity information received from the bank.

In some embodiments, the temporary transaction authorization information created for the new account is identical to the payment authorization information for the payment account. In some embodiments, the server of social network uses the same username, and password used for the payment account for the new account established with the broker. In some embodiments, the server of social network uses the username and password of a social network account as the temporary username and password of the new account established with the broker.

In some embodiments, the temporary transaction authorization information for the new account includes the authorization information for an account of a social network stored in the server. For example, the server may use the account name and password of a Facebook™ account of the user as the temporary account name and password.

In some embodiments, establishing the new account with the broker of the financial product further comprises: creating temporary transaction authorization information for the new account; and sending the temporary transaction authorization information with the user identity information to the broker server.

In accordance with some embodiments, after establishing the new account with the broker on behalf of the user, the server sends account information for the new account, including an account name and the temporary transaction authorization information to the user.

In some embodiments, the temporary transaction authorization information is sent to the social network application of the user. In some embodiments, the temporary transaction authorization information is sent to another account of the user. For example, a user may receive account information not through the social network application but through an email address that is associated with the user's account of the social network application.

In some embodiments, the server receives updated transaction authorization information from the user and forwards the updated transaction authorization information to the broker server to replace the temporary transaction authorization information for the new account. For example, after receiving the temporary username and password, the user resets the username and password and the mobile device sends the updated username and password to the server of the social network platform.

In step S906, in accordance with some embodiments, the server requests the broker to execute the purchase transaction using the new account established by the server on behalf of the user.

In some embodiments, requesting the broker to execute the purchase transaction further comprises: requesting the bank server to transfer required funds from the payment account into the new account established with the broker; and upon receiving a transfer confirmation from the bank server, sending an execution request to a broker server of the broker, wherein the execution request includes the temporary transaction authorization and the specified purchase transaction for the financial product.

In some embodiments, the transaction request includes a transaction time. For example, the user sets up a transaction request at 11 am Thursday with a transaction time at 3 pm Friday. The server may request the broker to execute the purchase transaction at 3 pm Friday.

In some embodiments, in accordance with a determination that the user has an existing account with the broker of the financial product, the server omits steps S904 and S905 and requests the broker to execute the purchase transaction with the existing account.

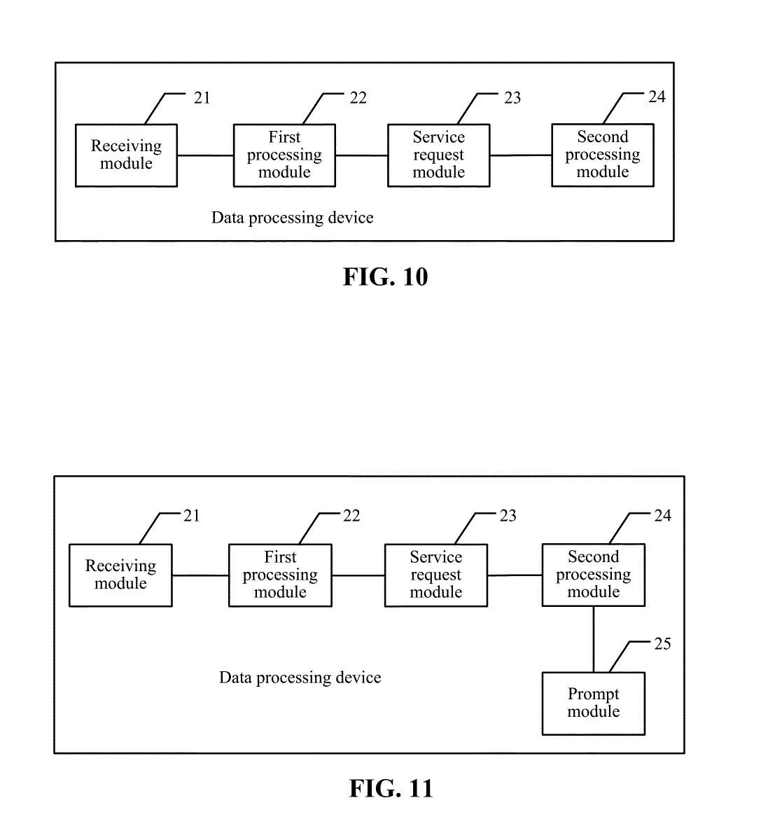

FIG. 10 is a schematic structural diagram of a data processing device in accordance with some embodiments. The device comprises:

a receiving module 21, for receiving verification information and user identity information sent by a terminal;

a first processing module 22, for executing transaction preparation of the user account corresponding to the terminal according to the verification information to obtain preparation result, and verifying the user identity information;

a service request module 23, for sending a service request comprising the user identity information to a service server when the verification succeeds; and

a second processing module 24, for performing transaction processing according to the amount, after receiving the target service information and obtaining a successful preparation result.

The first processing module 22 verifies the corresponding account and password in the verification information, and accomplishes the transaction preparation for the account in the verification information. And the first processing module 22 can particularly accomplish the transaction preparation by communicating with a server bound with the account or the user account number in the verification information and the terminal of the user. A processing result is obtained after transaction preparation is completed.

In some embodiments, the first processing module 22 verifies the user identity information through communication with a corresponding server in a household-registration service.

The service request module 23 initiates a service request to a service server and carries user identity information such as the ID card number and the real name of the user in the service request.

FIG. 11 is a schematic structural diagram of a data processing device in accordance with some embodiments, the device in accordance with some embodiments comprises the above-mentioned receiving module 21, first processing module 22, service request module 23 and second processing module 24.

The second processing module 24 is particularly used for acquiring the account of the user corresponding to the service server. And transferring the amount to the user account corresponding to the service server from the user account corresponding to the terminal.

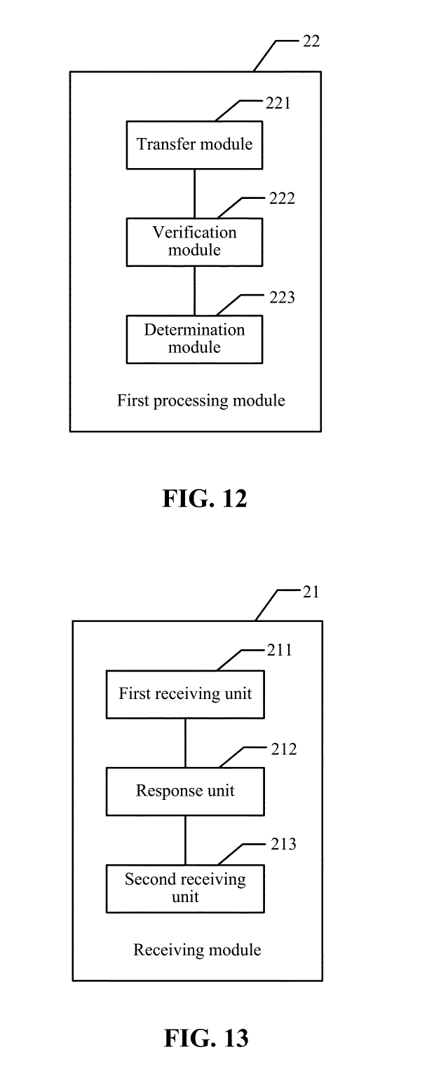

Optionally, as shown in FIG. 12, the first processing module 22 in accordance with some embodiments comprises: a transfer unit 221, for executing transaction; a verification unit 222, for generating an authentication; and a determination unit 223, for determining that the verification succeeds after receiving notification of authentication success from the authentication server.

Optionally, as shown in FIG. 13, the receiving module 21 in accordance with some embodiments comprises: a first receiving unit 211, for receiving a service trigger request and the user identity information; a response unit 212, for sending transaction request information to the terminal in response to the service trigger request; and a second receiving unit 213, for receiving verification information returned by the terminal in response to the transaction request.

Particularly, the first receiving unit 211 is used for receiving the user identity information entered in a user interface displayed when the terminal detects the service confirmation event; and the second receiving unit 213 is used for receiving the verification information entered in a user interface displayed when the terminal receives the transaction request information.

In some embodiments, the device comprises a prompt module 25, for sending prompt information about service processing success to a terminal after executing the transaction.

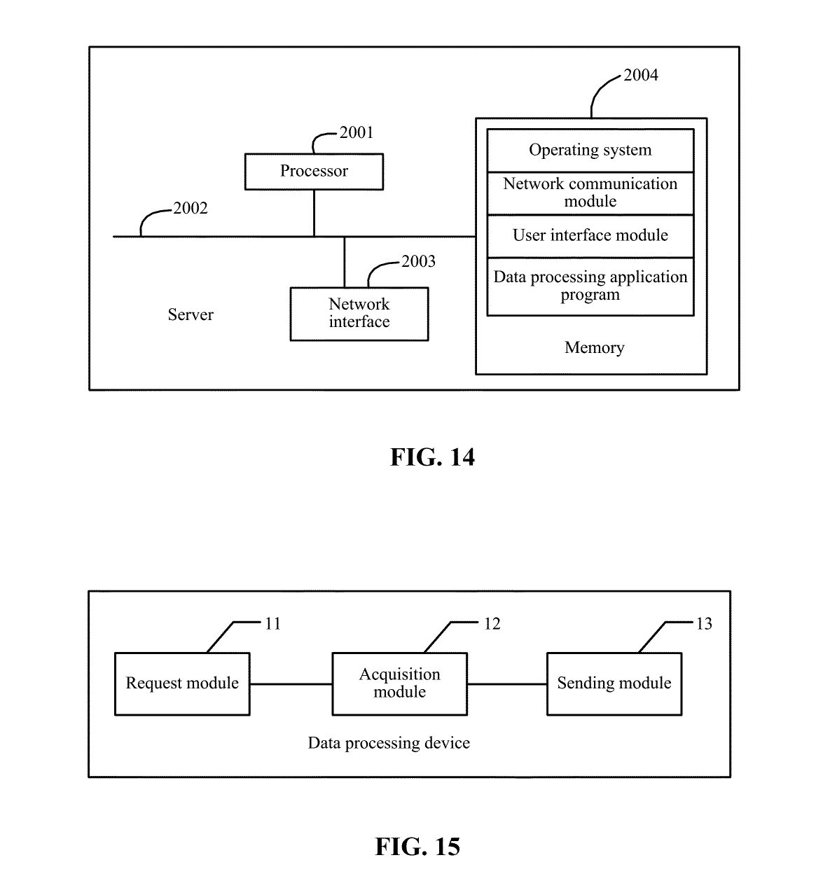

FIG. 14 is a schematic structural diagram of a server in accordance with some embodiments, the server in accordance with some embodiments comprises: at least one processor 2001, such as a CPU; at least one communication bus 2002; at least one network interface 2003 and a memory 2004. The communication bus 2002 is used for realizing connections and communications among these components. The network interface 2003 can optionally comprise a standard wired interface and wireless interface (for example, a WI-FI and a mobile communication interface). The memory 2004 is a high speed RAM memory and can also be a non-volatile memory, for example, at least one magnetic disk memory. The memory 2004 can also optionally be at least one storage device far away from the above-mentioned processor 2001. As shown in FIG. 14, as a computer storage medium, the memory 2004 stores an operating system and a network communication module, and also stores a data processing application program and other programs.

Particularly, the processor 2001 is used for calling the data processing application program stored in the memory 2004 to execute the following steps:

Receiving verification information and user identity information sent by a terminal;

Executing transaction preparation of the user account, obtaining preparation result and verifying the user identity information;

Sending a service request comprising the user identity information to a service server; and

Executing the transaction.

The processor 2001 may also be configured to perform other functions of the server described with respect to FIGS. 1-9.

FIG. 15 is a schematic structural diagram of a data processing device in accordance with some embodiments. The device is terminal 1 in the above-mentioned system embodiments. The device comprises: a request module 11, for generating a service trigger request and sending same to a data server when detecting a service confirmation event; an acquisition module 12, for acquiring user identity information and sending same to the data server; and a sending module 13, for acquiring verification information and sending same to the data server.

In some embodiments, the request module 11 can initiate a service trigger request to a data server and prompts to acquire the verification information about the user under the trigger of the data server. The acquisition module 12 and the sending module 13 can request the user to enter corresponding user identity information and verification information by displaying a user interface.

Particularly, the data processing device accomplishing the data processing in accordance with some embodiments corresponding to each module can refer to the description of the embodiments corresponding to the above-mentioned FIGS. 1-3.

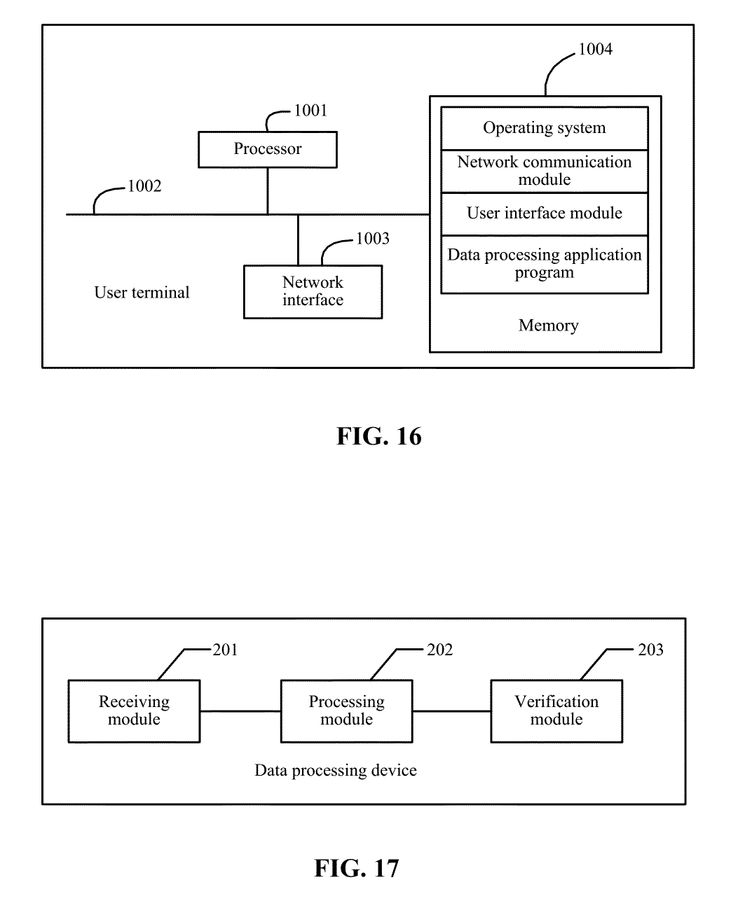

FIG. 16 is a schematic structural diagram of a user terminal in accordance with some embodiments. The user terminal in accordance with some embodiments comprises: at least one processor 1001, such as a CPU; at least one communication bus 1002; at least one network interface 1003. And a memory 1004. The communication bus 1002 is used for realizing connections and communications among these components. The network interface 1003 can optionally comprise a standard wired interface and wireless interface (for example, a WI-FI and a mobile communication interface). The memory 1004 is a high speed RAM memory and can also be a non-volatile memory, for example, at least one magnetic disk memory. The memory 1004 can also optionally be at least one storage device far away from the above-mentioned processor 1001. As shown in FIG. 16, as a computer storage medium, the memory 1004 stores an operating system and a network communication module, and also stores a data processing application program and other programs.

Particularly, the processor 1001 is used for calling the data processing application program stored in the memory 1004 to execute the following steps: generating a service trigger request and sending same to a data server; acquiring user identity information and sending same to the data server; and acquiring verification information and sending same to the data server, when sends it to a data server.

FIG. 17 is a schematic structural diagram of a data processing device in accordance with some embodiments, the device in accordance with some embodiments is provided in the above-mentioned first server, and the device particularly comprises:

a receiving module 201, for receiving verification information and user identity information sent by a terminal;

a processing module 202, for executing transaction preparation of the user account corresponding to the terminal according to the verification information to obtain preparation result;

a verification module 203, for verifying the user identity information, and sending the user identity information to a second server when the verification succeeds; and

The processing module 202 is also used for performing transaction processing according to the amount.

The particular implementation of the terminal obtaining the verification information and the user identity information can refer to the description of the embodiments corresponding to the above-mentioned FIGS. 1-5.

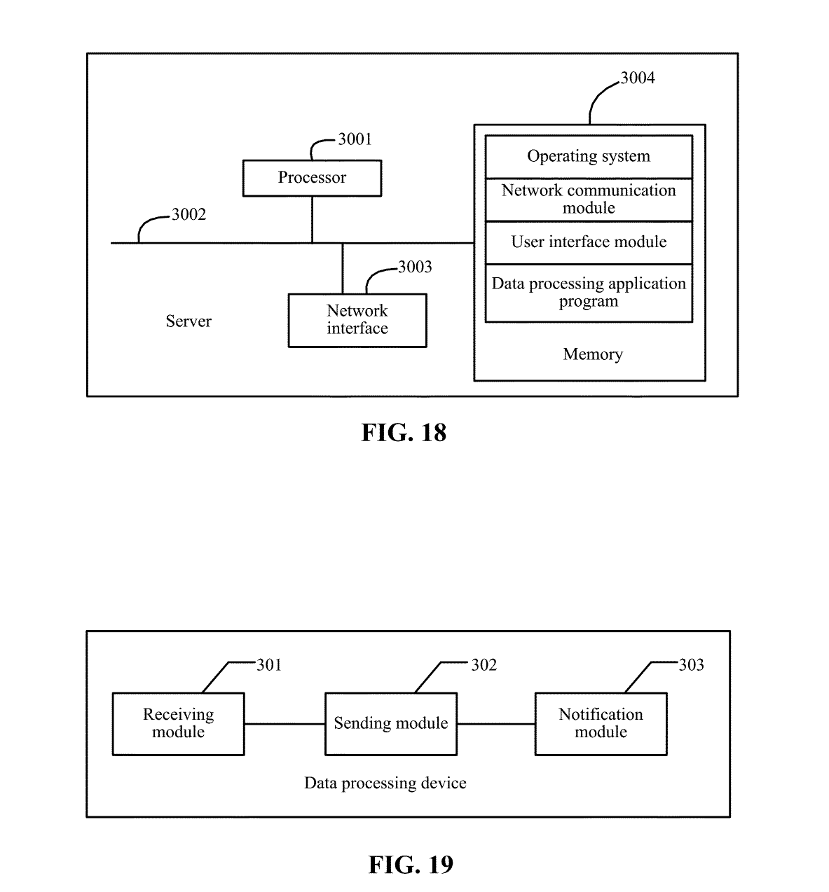

FIG. 18 is a schematic structural diagram of a server in accordance with some embodiments. The server in accordance with some embodiments comprises: at least one processor 3001, such as a CPU; at least one communication bus 3002; at least one network interface 3003. And a memory 3004. The communication bus 3002 is used for realizing connections and communications among these components. The network interface 3003 can optionally comprise a standard wired interface and wireless interface (for example, a WI-FI and a mobile communication interface). The memory 3004 is a high speed RAM memory and can also be a non-volatile memory, for example, at least one magnetic disk memory. The memory 3004 can also optionally be at least one storage device far away from the above-mentioned processor 3001. As shown in FIG. 18, as a computer storage medium, the memory 3004 stores an operating system and a network communication module, and also stores a data processing application program and other programs.

Particularly, the processor 3001 is used for calling the data processing application program stored in the memory 3004 to execute the following steps:

Receiving verification information and user identity information sent by a terminal;

Performing transaction preparation of the user account corresponding to the terminal according to the verification information to obtain preparation result;

Verifying the user identity information, and sending the user identity information to a second server when the verification succeeds; and

After receiving transaction processing notification sent by the second server, executing the transaction.

The processor 3001 may also be configured to perform other functions of the server described with respect to FIGS. 1-9.

FIG. 19 is a schematic structural diagram of a data processing device in accordance with some embodiments. The device in accordance with some embodiments is provided in the above-mentioned second server. The device comprises:

a receiving module 301, for receiving user identity information after being verified by a first server

a sending module 302, for initiating a service request comprising the user identity information to a service server; and

a notification module 303, for sending a transaction notification to the first server.

The methods of the first server acquiring and verifying user identity information can refer to the description of the embodiments corresponding to the above-mentioned FIGS. 1-6.

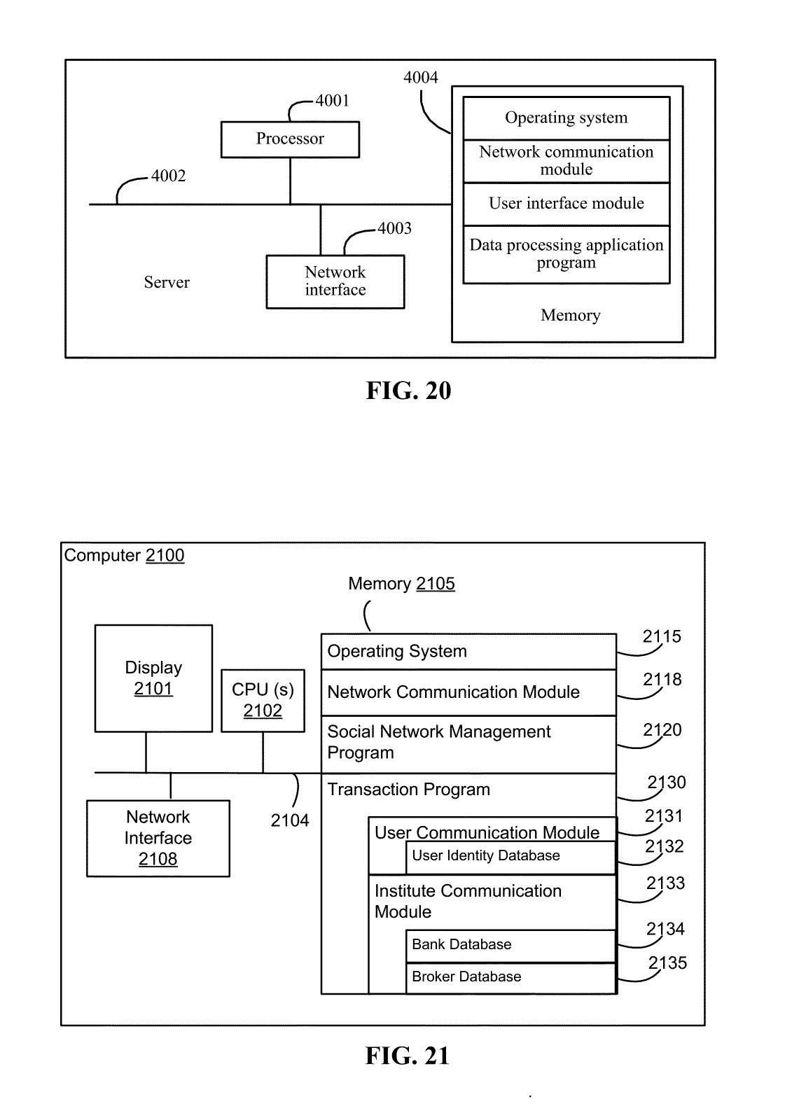

FIG. 20 is a schematic structural diagram of a server in accordance with some embodiments. The server in accordance with some embodiments comprises: at least one processor 4001, such as a CPU; at least one communication bus 4002; at least one network interface 4003. And a memory 4004. The communication bus 4002 is used for realizing connections and communications among these components. The network interface 4003 can optionally comprise a standard wired interface and wireless interface (for example, a WI-FI and a mobile communication interface). The memory 4004 is a high speed RAM memory and can also be a non-volatile memory, for example, at least one magnetic disk memory. The memory 4004 can also optionally be at least one storage device far away from the above-mentioned processor 4001. As shown in FIG. 20, as a computer storage medium, the memory 4004 stores an operating system and a network communication module, and also stores a data processing application program and other programs.

Particularly, the processor 4001 is used for calling the data processing application program stored in the memory 4004 to execute the following steps:

Receiving user identity information after being verified by a first server;

Initiating a service request comprising the user identity information to a service server; and

Sending a transaction notification to the first server, if the target service information is received and the processing success information obtained by the first server is received.

FIG. 21 is a diagram of an example implementation of a social network platform server 2100 in accordance with some embodiments. While certain specific features are illustrated, those skilled in the art will appreciate from the present disclosure that various other features have not been illustrated for the sake of brevity and so as not to obscure more pertinent aspects of the implementations disclosed herein. To that end, the transaction server 2100 includes one or more processing units (CPU's) 2102, one or more network or other communications interfaces 2108, a display 2101, memory 2105, and one or more communication buses 2104 for interconnecting these and various other components. The communication buses may include circuitry (sometimes called a chipset) that interconnects and controls communications between system components. The memory 2105 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 2105 may optionally include one or more storage devices remotely located from the CPU(s) 2102. The memory 2105, including the non-volatile and volatile memory device(s) within the memory 2105, comprises a non-transitory computer readable storage medium.

In some implementations, the memory 2105 or the non-transitory computer readable storage medium of the memory 2105 stores the following programs, modules and data structures, or a subset thereof including an operating system 2115, a network communication module 2118, a social network management program 2120 and a transaction program 2130.

In accordance with some embodiments, the operating system 2115 includes procedures for handling various basic system services and for performing hardware dependent tasks.

In accordance with some embodiments, the network communication module 2118 facilitates communication with other devices via the one or more communication network interfaces 2108 (wired or wireless) and one or more communication networks, such as the internet, other wide area networks, local area networks, metropolitan area networks, and so on.

In accordance with some embodiments, a social network management program 2120 is configured to manage and operate a social network platform.

In accordance with some embodiments, the transaction program 2130 is configured to process a transaction for users. In some embodiments, the transaction program 2130 comprises a user communication module 2131 and an institute communication module 2133.

In some embodiments, the user communication module 2131 is configured to communicate with users, such as providing a listing of financial products and/or brokers, receiving a transaction request from the mobile device, determining whether the user has an existing account with a broker of the financial product, identifying a payment account of the user that has been bound with the user's user account of the social networking platform. In some embodiments, the user communication module 2131 comprises a user identity database 2132. The user identity database is configured to store corresponding relationships among a user's user accounts of social network, authorization information, personal identity information, payment accounts, existing broker accounts, user identity information, payment authorization information, etc.

In some embodiments, the institute communication module 2133 is configured to communicate with institutes, including banks, brokers, funds, and any institutes managing the payment accounts. Specifically, the institute communication module 2133 is configured to establish a new account with the broker of the financial product, request the broker to execute the purchase transaction, send the payment authorization information to a bank server, and request the bank server to transfer required funds. The institute communication module 2133 comprises a bank database 2134 and a broker database 2135. The bank database 2134 is configured to store transaction related information of banks, e.g., IP addresses of bank servers and prior agreements between the social network platform and the banks The broker database 2135 is configured to store transaction related information of brokers, e.g., IP addresses of a broker servers, prior agreement between the social network platform and the broker, the financial products that the broker offers. This application describes various modes of processing a transaction, each requiring a different cooperation from banks and brokers. Each bank and broker may also have its own agreements, arrangements, and restrictions. The bank database 2134 and broker database 2135 are configured to store the information of the any of the agreements, arrangements, and restrictions and make the information accessible and meaningful for other modules of the server.

While particular embodiments are described above, it will be understood it is not intended to limit the disclosure to these particular embodiments. On the contrary, the technology includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the technology to the precise forms disclosed. Many modifications and variations are possible in view of the above teachings. The embodiments were chosen and described in order to best explain the principles of the technology and its practical applications, to thereby enable others skilled in the art to best utilize the technology and various embodiments with various modifications as are suited to the particular use contemplated.

What is claimed is:

1. A method of processing a financial product transaction, comprising:
at a server of a social network platform, the server having one or more processors and memory for storing one or more programs to be executed by the one or more processors:
receiving a transaction request from a mobile device, wherein the transaction request specifies a purchase transaction for a financial product;
in response to the transaction request, determining whether a user of the mobile device has an existing account with a broker of the financial product;
in accordance with a determination that the user does not have any existing account with the broker of the financial product, identifying a payment account of the user that has been bound with the user's account of the social networking platform;
based on user identity information and bank account information associated with the payment account, establishing a new account with the broker of the financial product on behalf of the user; and
requesting the broker to execute the purchase transaction using the new account established by the server on behalf of the user.

2. The method of claim 1, further comprising:
before receiving the transaction request from the mobile device, providing a listing of financial products offered by one or more brokers to the user through the mobile device associated with a user account of the social networking platform.

3. The method of claim 1, wherein based on the user identity information and the bank account information associated with the payment account, establishing the new account with the broker of the financial product on behalf of the user, further comprises:
identifying a bank account and payment authorization information of the user associated with the payment account;
sending the payment authorization information to a bank server that manages the bank account to request the user identity information associated with the payment account from the bank server;
if the bank authenticates the payment authorization information, receiving the user identity information from the bank server; and
establishing the new account with the broker of the financial product for the user using the received user identity information.

4. The method of claim 3, wherein establishing the new account with the broker of the financial product further comprises:
creating temporary transaction authorization information for the new account; and
sending the temporary transaction authorization information with the user identity information to the broker server.

5. The method of claim 4, wherein requesting the broker to execute the purchase transaction further comprises:
requesting the bank server to transfer required funds from the payment account into the new account established with the broker; and
upon receiving a transfer confirmation from the bank server, sending an execution request to the broker server of the broker, wherein the execution request includes the temporary transaction authorization and the specified purchase transaction for the financial product.

6. The method of claim 1, wherein based on the user identity information and the bank account information associated with the payment account, establishing the new account with the broker of the financial product on behalf of the user, further comprises:
obtaining user identity information stored in association with the payment account; and
sending the stored user identity information associated with the payment account to a broker server of the broker to establish the new account with the broker of the financial product.

7. The method of claim 1, wherein based on the user identity information and the bank account information associated with the payment account, establishing the new account with the broker of the financial product on behalf of the user, further comprises:
identifying a bank account and payment authorization information of the user associated with the payment account;
sending the payment authorization information to a bank server that manages the bank account to request that the bank server sends user identity information associated with the payment account to a broker server of the broker; and
requesting the broker to establish the new account for the user using the user identity information the broker sever receives from the bank server.

8. The method of claim 7, wherein requesting the broker to establish the new account for the user using the user identity information the broker server receives from the bank server further comprises:
creating temporary transaction authorization information for the new account; and
sending the temporary transaction authorization information in a request to the broker server, wherein the request identifies the bank account of the user.

9. The method of claim 1, further comprising:
after establishing the new account with the broker on behalf of the user,
sending account information for the new account, including an account name and the temporary transaction authorization information to the user.

10. The method of claim 9, further comprising:
receiving updated transaction authorization information from the user; and
forwarding the updated transaction authorization information to the broker server to replace the temporary transaction authorization information for the new account.

11. A server of a social network platform, comprising:
one or more processors; and
memory storing one or more programs for execution by the one or more processors, the one or more programs including instructions for:
receiving a transaction request from a mobile device, wherein the transaction request specifies a purchase transaction for a financial product;
in response to the transaction request, determining whether a user of the mobile device has an existing account with a broker of the financial product;
in accordance with a determination that the user does not have any existing account with the broker of the financial product, identifying a payment account of the user that has been bound with the user's account of the social networking platform;
based on user identity information and bank account information associated with the payment account, establishing a new account with the broker of the financial product on behalf of the user; and
requesting the broker to execute the purchase transaction using the new account established by the server on behalf of the user.

12. The server of claim 11, wherein based on the user identity information and the bank account information associated with the payment account, establishing the new account with the broker of the financial product on behalf of the user, further comprises:
identifying a bank account and payment authorization information of the user associated with the payment account;
sending the payment authorization information to a bank server that manages the bank account to request the user identity information associated with the payment account from the bank server;
if the bank authenticates the payment authorization information, receiving the user identity information from the bank server; and
establishing the new account with the broker of the financial product for the user using the received user identity information.

13. The server of claim 12, wherein establishing the new account with the broker of the financial product further comprises:
creating temporary transaction authorization information for the new account; and
sending the temporary transaction authorization information with the user identity information to the broker server.

14. The server of claim 13, wherein requesting the broker to execute the purchase transaction further comprises:
requesting the bank server to transfer required funds from the payment account into the new account established with the broker; and
upon receiving a transfer confirmation from the bank server, sending an execution request to the broker server of the broker, wherein the execution request includes the temporary transaction authorization and the specified purchase transaction for the financial product.

15. The server of claim 11, wherein based on the user identity information and the bank account information associated with the payment account, establishing the new account with the broker of the financial product on behalf of the user, further comprises:
obtaining user identity information stored in association with the payment account; and
sending the stored user identity information associated with the payment account to a broker server of the broker to establish the new account with the broker of the financial product.

16. The server of claim 11, wherein based on the user identity information and the bank account information associated with the payment account, establishing the new account with the broker of the financial product on behalf of the user, further comprises:
identifying a bank account and payment authorization information of the user associated with the payment account;
sending the payment authorization information to a bank server that manages the bank account to request that the bank server sends user identity information associated with the payment account to a broker server of the broker; and
requesting the broker to establish the new account for the user using the user identity information the broker sever receives from the bank server.

17. The server of claim 16, wherein requesting the broker to establish the new account for the user using the user identity information the broker server receives from the bank server further comprises:
creating temporary transaction authorization information for the new account; and
sending the temporary transaction authorization information in a request to the broker server, wherein the request identifies the bank account of the user.

18. The server of claim 11, further comprising:
after establishing the new account with the broker on behalf of the user,
sending account information for the new account, including an account name and the temporary transaction authorization information to the user.

19. The server of claim 18, further comprising:
receiving updated transaction authorization information from the user; and
forwarding the updated transaction authorization information to the broker server to replace the temporary transaction authorization information for the new account.

20. A non-transitory computer readable storage medium having instructions stored thereon, the instructions, when executed by one or more processors, cause the processors to perform operations comprising:
receiving a transaction request from a mobile device, wherein the transaction request specifies a purchase transaction for a financial product;
in response to the transaction request, determining whether a user of the mobile device has an existing account with a broker of the financial product;
in accordance with a determination that the user does not have any existing account with the broker of the financial product, identifying a payment account of the user that has been bound with the user's account of the social networking platform;
based on user identity information and bank account information associated with the payment account, establishing a new account with the broker of the financial product on behalf of the user; and
requesting the broker to execute the purchase transaction using the new account established by the server on behalf of the user.
